(19) United States
(12) Patent Application Publication
(10) Pub. No.: US 2009/0143982 A1
(43) Pub. Date: Jun. 4, 2009

(54) Method For Operating A Navigation Device

(76) Inventors: Jochen Katzer, Gallmersgarten-Bergtshofen (DE); Thorsten W. Schmidt, Kitzingen (DE); Matthias Kahlow, Wurzburg (DE)

Correspondence Address: QUARLES & BRADY LLP, 411 E. WISCONSIN AVENUE, SUITE 2040, MILWAUKEE, WI, 53202-4497, US

(21) Appl. No.: 12/277,968

(22) Filed: Nov. 25, 2008

(30) Foreign Application Priority Data
Dec. 4, 2007 (DE) 10 2007 058 651.7

(51) Int. Cl. G01C 21/00; G10L 13/00

(52) U.S. Cl. 701/213; 704/258; 704/E13.001

(57) ABSTRACT

A method for operating a navigation device that includes an input device for inputting operator commands and/or locations, particularly starting points and/or destinations, a road network database, a route calculation unit for calculating a planned route with consideration of the locations and the road network database, wherein the route leads from the starting point to the destination, a signal receiving unit for receiving position signals, particularly GPS signals, a position determining unit that determines the current position based on the position signals, and a voice output module that is able to generate and acoustically output a voice message, particularly maneuvering instructions, in dependence on predetermined boundary conditions by combining at least two voice message elements, wherein the voice message elements to be combined are analyzed prior to the acoustic output of the voice message, and wherein the voice message is changed in accordance with predetermined prioritization rules depending on the result of the analysis.

### CROSS-REFERENCE TO RELATED APPLICATION

This application claims the priority benefit of German Patent Application No. 10 2007 058 651.7 filed on Dec. 4, 2007, the contents of which are hereby incorporated by reference as if fully set forth herein in their entirety.

### STATEMENT CONCERNING FEDERALLY SPONSORED RESEARCH OR DEVELOPMENT

Not applicable.

### FIELD OF THE INVENTION

The invention pertains to a method for operating a navigation device including an input device for inputting operator commands and/or locations, particularly starting points and/or destinations, a road network database, a route calculation unit for calculating a planned route with consideration of the locations and the road network database, wherein the route leads from the starting point to the destination, a signal receiving unit for receiving position signals, particularly GPS signals, a position determining unit that determines the current position based on the position signals, and a voice output module that is able to generate and acoustically output a voice message.

### BACKGROUND OF THE INVENTION

Navigation devices of the generic type may consist, for example, of mobile navigation devices for use in motor vehicles or of mobile telephones with corresponding navigation software installed thereon and serve for directing the user from a starting point to a destination. Devices known from the state of the art are usually provided with a monitor in order to display instructions and menus on this user interface. Many known navigation devices additionally feature an acoustic user interface. This acoustic user interface makes it possible to announce text messages in an acoustic form, wherein this is particularly advantageous in the use of motor vehicles. These voice messages are generated with voice output modules that consist of a plurality of individual voice message elements stored in a database and generate the respective voice messages by combining at least two different voice message elements. This makes it possible to generate a very large number of different voice messages in a combinatorial fashion with a relatively small number of different voice message elements. The individual voice message elements can either be generated electronically from texts (text-to-speech) or the voice message elements may consist of individual acoustic voice sequences.

In a navigation device known from EP 0 722 559 B1, voice messages are combined of several voice message elements.

In the known navigation devices, the current voice messages are initially generated by combining individual voice message elements in order to create a chain of voice message elements that is subsequently stored in an intermediate memory in the form of a sequence of operations to be executed. The individual voice message elements are retrieved from the intermediate memory and output in acoustic form in accordance with their sequence. After the acoustic output, the individual voice message elements are deleted from the intermediate memory. Consequently, the intermediate memory with the current voice message elements stored therein is operated in accordance with a FIFO storage (First In First Out).

In certain situations, however, it may be sensible to delete individual voice message elements from the voice message or to change the sequence of the voice message elements. For example, if the driver exceeds the respectively applicable speed limit, it is not sensible to delay the output of the corresponding warning message until all acoustic voice message elements already stored in the intermediate memory have been processed and output.

In addition, the acoustic voice output is associated with the basic problem that a balance between information content and timeliness needs to be found. For example, it is sensible to issue brief and concise instructions if the driver needs to execute several maneuvers in succession. If only a few maneuvers are imminent, however, the system should provide the full information content. For example, the output of street names assigned to the individual maneuvers is only sensible if sufficient time is available for the voice output of the individual maneuvering instructions.

The voice messages of known navigation devices cannot be adapted to different situations in a differentiated fashion.

### SUMMARY OF THE INVENTION

Based on this state of the art, the present invention therefore aims to propose a navigation device with improved voice output. In a preferred embodiment, the voice message elements to be combined are analyzed prior to the acoustic output of the voice message, wherein the voice message is changed in accordance with predetermined prioritization rules depending on the result of the analysis. Most preferably, prioritization rules are evaluated in order to change the voice message in accordance with the boundary conditions of the prioritization rules.

The voice message elements to be combined may basically be analyzed in any suitable way. The analysis is simplified, in particular, if prioritization parameters are assigned to the individual voice message elements. In this case, the prioritization parameters of all current voice messages can be analyzed during the generation or processing of a voice message in order to subsequently change the voice message to be acoustically output in accordance with predetermined prioritization rules, namely depending on the currently applicable prioritization parameters.

The voice message may also be changed by analyzing the prioritization parameters and utilizing predetermined prioritization rules in any suitable way. According to a first variation of the method, the voice message may be changed by deleting individual voice message elements.

Alternatively or additionally, the voice message may also be changed by replacing one voice message element with another voice message element. This is particularly sensible if the complete voice message is excessively long and the duration of the voice message can be shortened by replacing a long voice message element with a shorter voice message element.

According to a third variation of the method, the voice message can also be changed by changing individual voice message elements themselves.

Different aspects of the invention are described in an exemplary fashion below.

### DETAILED DESCRIPTION OF THE EXAMPLE EMBODIMENTS

In a preferred embodiment of the present invention, a navigation device including an input device for inputting operator commands and/or locations, particularly starting points and/or destinations, a road network database, a route calculation unit for calculating a planned route with consideration of the locations and the road network database, wherein the route leads from the starting point to the destination, a signal receiving unit for receiving position signals, particularly GPS signals, a position determining unit that determines the current position based on the position signals, and a voice output module that is able to generate and acoustically output a voice message, particularly maneuvering instructions, in dependence on predetermined boundary conditions by combining at least two voice message elements, is operated in accordance with the inventive method of operation described below. Importantly, the method of operation includes analyzing the voice message elements to be combined prior to acoustically outputting the voice message, wherein the voice message is changed in accordance with predetermined prioritization rules depending on the result of the analysis

The inventive option of changing voice messages in dependence on the respective situation opens up a new application spectrum. For example, the user is able to adapt the characteristics of the voice output to his personal preferences. For this purpose, at least one prioritization rule is provided that contains a user adjustment stored in the navigation device. This user adjustment can be changed by the user at any time. The voice message can then be changed in dependence on this user adjustment during the combination of the individual voice message elements. For example, if the user prefers brief and concise instructions, the preferred deletion of less significant voice message elements can be adjusted in a user-defined fashion. This would enable the user, for example, to basically suppress the output of street names.

According to one alternative variation, at least one prioritization rule contains a manufacturer adjustment that cannot be changed by the user. This enables the manufacturer to easily adapt the characteristics of the voice output by means of this manufacturer adjustment. Consequently, the manufacturer can switch off individual voice output functions without actually altering the software for the voice output in order to justify the corresponding pricing.

With respect to user adjustments and manufacturer adjustments, it is particularly advantageous if process parameters of the navigation device are also taken into account in the prioritization rules. In this case, the voice output can be changed by correspondingly changing the voice message in dependence on the different process parameters of the navigation device.

By taking into account process parameters, it is possible, for example, to adapt voice messages having a certain position reference, such as, for example, position-related maneuvering announcements, to the corresponding driving situation. This is preferably realized by predicting the driving time that remains for the output of the position-related voice message and forwarding this driving time to the voice output module in the form of a process parameter. This remaining driving time can be compared with the time required for the acoustic output of the voice message and the voice message can subsequently be changed in dependence on the result of the comparison. For example, if the remaining driving time no longer suffices for the acoustic output of the voice message because a maneuver to be announced is imminent, the maneuvering instructions can be changed accordingly, particularly shortened. In the acoustic voice output of navigation devices, it needs to be taken into account that there exist highly significant voice message elements and less significant voice message elements. In order to appropriately take into account the different significance of individual voice message elements, it is possible to use prioritization parameters in the form of quantified prioritization values, particularly discrete priority stages. In this case, a fixed assignment of these prioritization values to the individual voice message elements is realized. Due to these measures, a comparison between the significance of the different prioritization values can be carried out when the prioritization values of the individual voice message elements are analyzed such that, in particular, a suitable sequence of the different voice message elements can be derived thereof.

The comparison between the remaining driving time and the time required for the acoustic output is significantly simplified if the time required for the acoustic output of the voice message or individual voice message elements is already stored together with the content of the voice message. For this purpose, the corresponding quantitative time values may be stored in a database together with the voice message elements, for example, or, in case of text-to-speech applications, can be calculated while the voice message elements are generated.

The analysis of the prioritization parameters of the individual voice message elements can be carried out in a particularly simple fashion if all currently output voice message elements are intermediately stored in an intermediate memory. Depending on the analysis of the individual prioritization parameters, individual voice message elements can be deleted from this chain of current voice message elements and/or the sequence of the acoustic output can be changed.

If the individual current voice message elements are intermediately stored in an intermediate memory in the form of a chain, the inventive analysis of the prioritization parameters should always be carried out automatically when a new voice message element is stored in the intermediate memory. This ensures that the chain of voice message elements always corresponds to the current prioritization situation.

In order to achieve a simple suppression of individual voice message elements, a zero prioritization value can be assigned to the voice message elements to be suppressed. For example, if a user specifies in his user adjustment that no street names should basically be output, a zero prioritization value can be assigned to all street names. During the voice output itself, voice message elements assigned with a zero prioritization value are not acoustically output.

This suppression of individual voice message elements is also particularly sensible if a language-specific voice synthesis module is used for synthesizing the voice message elements in a certain national language. If voice messages should be output that correspond to another national language, this cannot be realized with the voice synthesis module that is specific to the national language. In order to prevent corresponding program errors in this respect, a zero prioritization value can be assigned to all voice message elements that correspond to a national language other than that of the voice synthesis module used. These voice message elements that are incompatible with the voice synthesis module can then be easily suppressed.

The inventive method is elucidated below with reference to a few simple examples:

An acoustic announcement of a navigation system without ancillary information could read:
“In 3 km exit right.”

The same announcement with ancillary information could read:
“In 3 km exit right from the autobahn at the exit South-Cologne.”

For the acoustic output of both messages, a chain of the following voice message elements could be intermediately stored in the voice output module of the navigation system:
In 3 km exit right <start1> from the autobahn <end1><start2> at the exit South-Cologne <end2>.

The beginning and the end of the optional message elements “at the exit South-Cologne” and “from the autobahn” are respectively identified by markers placed within angled brackets. In this case, the individual markers additionally contain numerical values that characterize the priority values of the individual message elements. The individual markers placed within angled brackets are not actually output acoustically, but rather merely serve for enabling the voice output module to identify the optional message elements.

According to a second example, the following chain of voice message elements may be intermediately stored in the intermediate memory:
Now exit right <start1> from the autobahn <end1><start2> at the exit <end2><start2> to Beethovenstrasse <end2>.

This combination of voice message elements that is intermediately stored in the intermediate memory should be output within a short period of time. At this time, however, the following voice message is also stored in the intermediate memory:
Now turn left <start2> to Mozartstrasse <end2>.

The voice output module determines that high priority information is contained in the new announcement. This high priority information is intermediately stored without separate markers in the described variation of the method. This makes it possible to easily integrate voice message elements with equally high prioritization that possibly are already intermediately stored into the voice output, namely because voice message elements without markers represent valid statements.

In order to output the second announcement in a timely fashion, the announcement prioritized in queue is checked as to the fact if the announcement contains message elements of a lower priority. During this process, it is determined that the announcement contains two components with the priority 2. Since this priority is lower than the highest priority of the voice message that was subsequently stored in the intermediate memory, these voice message elements are deleted from the intermediate memory.

Subsequently, it can be checked if the first announcement is sufficiently short such that sufficient time remains after its output for also outputting the second announcement in a timely fashion.

This check can subsequently also be repeated for the voice message elements with the priority 1, wherein these voice message elements are also deleted from the intermediate memory after this check for priority stage 1 has been carried out, such that the following announcement is initially output:
“Now turn right.”

Subsequently, the following announcement is output:
“Now turn left to Mozartstrasse.”

For example, if a warning with respect to exceeding a speed limit immediately follows the second announcement, this warning could read as follows:
<start3> Warning <end3>.

If it is determined during the analysis that no element of the most recent announcement is assigned a higher priority than a component of the preceding message, the preceding message is output in unchanged form and the most recent message is not output until the preceding voice messages have been acoustically output in their entirety.

An announcement with alternative components could read as follows:
<start1> In 153.8 meters/in 150 meters/immediately <end1> turn right.

If only a very short time is available for a voice message, the voice message between the markers is completely omitted. However, if the time suffices for the voice output, the alternative between the markers that can still be output within the available time is selected in dependence on the length of the remaining time for the voice output.

In order to better estimate the output time for each alternative of the voice message elements required for the acoustic output thereof, the corresponding time values (duration=time value) of the individual voice message elements are stored in the memory and assigned to the different voice message elements in the following example:
<start1><start option duration=“4”> In 153.8 meters <end option><start option duration=“3”> in 150 meters <end option><start option duration=“1”> immediately <end option><end1>

In this example, it can be immediately determined during the readout of the three alternative voice message elements that the output of the first and most explicit voice message element (in 153.8 meters) requires 4 seconds while the output of the slightly shorter second voice message element (in 150 meters) only requires 3 seconds. The shortest voice message element (immediately) that requires less information content can be acoustically output in only 1 second. If sufficient time is available for the voice output, it is therefore possible to output the first alternative of the three possible voice message elements, wherein the shortest voice message element should be used if a maneuver is imminent.

While there has been shown and described what are at present considered the preferred embodiment of the invention, it will be obvious to those skilled in the art that various changes and modifications can be made therein without departing from the scope of the invention defined by the appended claims. Therefore, various alternatives and embodiments are contemplated as being within the scope of the following claims particularly pointing out and distinctly claiming the subject matter regarded as the invention.

1. A method for operating a navigation device including
an input device for inputting operator commands and/or locations, particularly starting points and/or destinations,
a road network database,
a route calculation unit for calculating a planned route with consideration of the locations and the road network database, wherein the route leads from the starting point to the destination,
a signal receiving unit for receiving position signals, particularly GPS signals,
a position determining unit that determines the current position based on the position signals, and
a voice output module that is able to generate and acoustically output a voice message, particularly maneuvering instructions, in dependence on predetermined boundary conditions by combining at least two voice message elements,
said method comprising:
analyzing the voice message elements to be combined prior to acoustically outputting the voice message, wherein the voice message is changed in accordance with predetermined prioritization rules depending on the result of the analysis.

2. The method according to claim 1, in which a prioritization parameter is assigned to at least one voice message element, wherein the prioritization parameters of the voice message elements to be combined are analyzed prior to the acoustic output of the voice message, and wherein the voice message is changed in accordance with predetermined prioritization rules depending on the prioritization parameters.

3. The method according to claim 1, in which at least one voice message element is deleted from the voice message in order to change the voice message.

4. The method according to claim 1, in which at least one voice message element in the voice message is replaced with another voice message element, particularly a shorter voice message element, in order to change the voice message.

5. The method according to claim 1, in which at least one voice message element in the voice message is changed in order to change the voice message.

6. The method according to claim 1, in which at least one prioritization rule contains a user adjustment that is stored in the navigation device and can be changed by the user, wherein the voice message is changed depending on the user adjustment.

7. The method according to claim 1, in which at least one prioritization rule contains a manufacturer adjustment that is stored in the navigation device and cannot be changed by the user, wherein the voice message is changed depending on the manufacturer adjustment of the process parameter.

8. The method according to claim 1, in which at least one prioritization rule contains a process parameter of the navigation device, wherein the voice message is changed depending on this process parameter.

9. The method according to claim 1, in which at least one voice message element is assigned to a certain output position, particularly a position-related maneuvering announcement, wherein the remaining driving time required for driving from the current position to the output position of the voice message element is predicted and forwarded to the voice output module in the form of a process parameter in order to change the voice message.

10. The method according to claim 9, in which the remaining driving time is compared with the output time required for the acoustic output of the voice message or with the output times required for the acoustic output of the individual voice message elements and the voice message is changed depending on the result of the comparison.

11. The method according to claim 9, in which the output time required for the acoustic output of the voice message or the output times required for the acoustic output of the individual voice message elements are stored in the form of an inaudible part of the voice message.

12. The method according to claim 9, in which quantified prioritization values, particularly discrete priority stages, are used as prioritization parameters, wherein a comparison between the significances of the prioritization values of the voice message elements is carried out when the prioritization values are analyzed.

13. The method according to claim 12, in which all voice message elements to be currently output are intermediately stored in an intermediate memory, wherein individual voice message elements are deleted from the intermediate memory or the sequence of the acoustic output of the voice message elements intermediately stored in the intermediate memory is changed depending on the respective prioritization value.

14. The method according to claim 13, in which the prioritization parameters of all voice message elements stored in the intermediate memory are automatically analyzed each time a new voice message element is intermediately stored.

15. The method according to claim 1, in which a zero prioritization value is assigned to individual voice message elements in order to suppress the acoustic output of these voice message elements.

16. The method according to claim 15, in which the acoustic output of optional voice message elements such as, for example, street names, is suppressed by means of a user adjustment, namely by assigning the zero prioritization value to these optional voice message elements depending on the user adjustment.

17. The method according to claim 15, in which the acoustic output of voice message elements is synthesized in a voice synthesis module that is assigned to a certain national language, wherein the zero prioritization value is assigned to voice message elements that are assigned to another national language.
